(19) United States
(12) Patent Application Publication
(10) Pub. No.: US 2026/0113386 A1
(43) Pub. Date: Apr. 23, 2026

(54) INTEGRATION OF CARD-BASED REWARDS WITH MULTI-WAVE ONLINE USER TRACKING

(71) Applicant: KwikClick, LLC, Murray, UT (US)

(72) Inventor: Fred Cooper, Farmington, UT (US)

(21) Appl. No.: 18/133,766

(22) Filed: Apr. 12, 2023

Related U.S. Application Data
(60) Provisional application No. 63/330,202, filed on Apr. 12, 2022.

(51) Int. Cl. H04L 67/50; G06Q 30/0226

(52) U.S. Cl. CPC H04L 67/535; G06Q 30/0226

(57) ABSTRACT

Systems and methods are provided for integrating multi-wave user tracking into an existing rewards processing system. An online user may activate a coded link to a website or web application. The coded link is a link in which a unique code has been embedded, and the unique code may be associated with one or more upline users. Activation of the coded link may result in automatic generation of a specific graphical user interface associated with one or more online activities available at the website. If the user elects and proceeds with one or more online activities at the website, then the code embedded in the coded link may be used to associate such online activities with the upline users. Different rewards may be assigned to a respectively associated rewards card of the upline users. The rewards card may include a credit card, debit card, loyalty card, gift card, or any other card that can be used to apply rewards to a purchase.

### CROSS-REFERENCE TO RELATED APPLICATION

The present application claims the priority benefits of U.S. provisional application number 63/330,202 filed Apr. 12, 2022, the disclosure of which is incorporated herein by reference.

### BACKGROUND OF THE INVENTION

### Field of the Invention

The present disclosure is generally related to multi-level user structures. More specifically, the present disclosure is directed to integrating card-based rewards with multi-wave user structures that track online activities based on unique codes embedded in associated web links.

### Description of the Related Art

Multi-level marketing (MLM) is a sales strategy used by some direct sales companies, which is used to encourage existing distributors to recruit new distributors who are paid a percentage of their recruits'sales. The recruits are the distributor's “downline.” Distributors also make money through direct sales of products to customers. Amway, which sells health, beauty, and home care products, is an example of a well-known direct sales company that uses multi-level marketing.

Multi-level marketing is a legitimate business sales strategy. As MLM is organized as a pyramid tree, it is often misconstrued as a pyramid scheme. However, pyramid “schemes” that use money from new recruits to pay people at the top rather than those who perform the work are illegal. These pyramid schemes involve taking advantage of people by pretending to be engaged in legitimate multi-level or network marketing. Pyramid schemes can be spotted by their greater focus on recruitment than on product sales.

One issue in determining the legitimacy of a multi-level marketing company is whether it sells its products primarily to consumers or to its members, who must recruit new members to buy their products. If it is the former, the company is likely a legitimate multi-level marketer. If it is the latter, it could be an illegal pyramid scheme.

Although each MLM company dictates its own specific financial compensation plan for the payout of any earnings to their respective participants, the common feature across all MLMs is that the compensation plans theoretically payout to participants only from two potential revenue streams. The first is paid out from commissions of sales made by the participants directly to their retail customers. The second is paid out from commissions based upon the wholesale purchases made by other distributors below the participant who have recruited those other participants into the MLM; in the organizational hierarchy of MLMs, these participants are referred to as one's downline distributors.

Therefore, MLM salespeople (distributors) are expected to sell products directly to end-user retail consumers through relationship referrals and word of mouth marketing. Still, most importantly, they are incentivized to recruit others to join the company's distribution chain as fellow salespeople to become downline distributors.

Currently, joining an MLM requires an initiation fee which may be too steep for those who simply want to refer a single product they like. This means that current multi-level marketing systems do not fully leverage the potential of the internet in terms of how consumers can influence other buyers. Further, these systems lack incentives for users as there is no dynamic commission tree. Moreover, money or funds dedicated to discounts and coupons are not reincorporated into the MLM system to incentivize consumers. This is further compounded by the fact that users cannot use their existing credit, debit or rewards cards for referral code e-commerce without an integrated system. A credit, debit, or rewards card integrated with the MLM system can help overcome these issues and make it easier for users to take advantage of the incentives offered.

MLMs are generally not designed to track digital or online activities, such as online card usage. Nor are MLMs generally designed to increase traffic to a particular application or website, as tracking online visitors or actions can be difficult to attribute to multiple levels or upstream actors or actions. This limitation of current MLMs prevents them from being used to track Internet and their respective online activities, let alone being able to track their downstream contact circles and their respective online activities (e.g., at websites or via web applications).

Conversely, presently available systems for tracking online activities do not track complex, multi-level relationships between different online users so as to be able to identify which users may be responsible for certain online activities or actions of other users. Nor do most online websites or web applications track multiple levels of upline or downline users that may have contributed to another user's online activities, leading to the inability to treat such online actions (e.g., taken at a website or via web application) differently based on such relationships.

There is therefore a need in the art for improved system and methods of incorporating online wagers into multi-wave user tracking systems.

### SUMMARY OF THE CLAIMED INVENTION

Embodiments of the present invention include systems and methods for integrating multi-wave user tracking into an existing rewards processing system. An online user may activate a coded link to a website or web application. The coded link is a link in which a unique code has been embedded, and the unique code may be associated with one or more upline users. Activation of the coded link may result in automatic generation of a specific graphical user interface associated with one or more online activities available at the website. If the user elects and proceeds with one or more online activities at the website, then the code embedded in the coded link may be used to associate such online activities with the upline users. Different rewards may be assigned to a respectively associated rewards card of the upline users. The rewards card may include a credit card, debit card, loyalty card, gift card, or any other card that can be used to apply rewards to a purchase.

### BRIEF DESCRIPTIONS OF THE DRAWINGS

FIG. 1 illustrates a system for Multi-Level Marketing of products via a set of computing devices, according to the present disclosure.

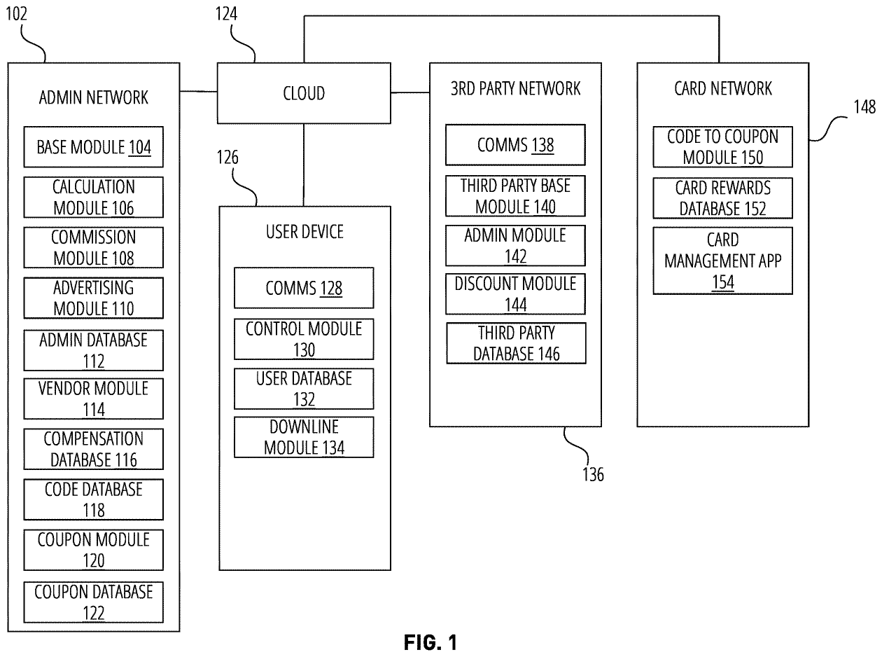

FIG. 2 displays the method for the Admin Network Base Module 104, according to some aspects of the disclosure.

FIG. 3 displays the method for the Admin Network Calculation Module 106 according to some aspects of the disclosure.

FIG. 4 displays the method for the Admin Network Commission Module 108, according to some aspects of the disclosure.

FIG. 5. displays the method for the Admin Network Advertising Module, according to some aspects of the disclosure.

FIG. 6 displays the Admin Network Admin Database, created through the Admin Network Vendor Module according to some aspects of the present disclosure.

FIG. 7. displays the method for the Admin Network Vendor Module according to some aspects of the disclosure.

FIG. 8 illustrates a Compensation Database, according to some aspects of the present disclosure.

FIG. 9 illustrates a Code Database, according to some aspects of the present disclosure.

FIG. 10 displays the method for the Admin Network Coupon Module, according to some aspects of the disclosure.

FIG. 11 displays the Admin Network Coupon Database according to some aspects of the disclosure.

FIG. 12 displays the method for the User Device control module of the User device according to some aspects of the disclosure.

FIG. 13 displays the User Device User Database, containing the user's downline users as well as the downline users'information according to some aspects of the disclosure.

FIG. 14 displays the method for the User Device Downline Module, according to some aspects of the disclosure.

FIG. 15 displays the method for the third party base module of the third 3rd party network, according to some aspects to the disclosure.

FIG. 16 displays the method for the 3rd Party Network Admin Module according to some aspects of the disclosure.

FIG. 17 displays the method for the Discount Module, according to some aspects of the disclosure.

FIG. 18 displays the 3rd party database of the 3rd Party Network, according to some aspects of the disclosure.

FIG. 19 displays the method for the Code to Coupon Module, according to some aspects of the disclosure.

FIG. 20 displays the Card Rewards Database according to some aspects of the disclosure.

### DETAILED DESCRIPTION

Embodiments of the present invention include systems and methods for integrating multi-wave user tracking into an existing rewards processing system. An online user may activate a coded link to a website or web application. The coded link is a link in which a unique code has been embedded, and the unique code may be associated with one or more upline users. Activation of the coded link may result in automatic generation of a specific graphical user interface associated with one or more online activities available at the website. If the user elects and proceeds with one or more online activities at the website, then the code embedded in the coded link may be used to associate such online activities with the upline users. Different rewards may be assigned to a respectively associated rewards card of the upline users. The rewards card may include a credit card, debit card, loyalty card, gift card, or any other card that can be used to apply rewards to a purchase. “MLM Distributor” refers to the non-salaried workforce selling the company's products or services, while the earnings of the participants are derived from a pyramid-shaped or binary compensation commission system. “MLM Distributors” can be integrated into this system or method in many elements or steps of this disclosure.

“Distributor Contact List or followers” refers to the recruits or followers on social media that a distributor has secured to participant in their downline. “Distributor Contact List or followers” can be integrated into this system or method in many elements or steps of this disclosure.

“Upline” refers to the MLM distributors that recruit work for as salespeople to sell the products or services. “Upline” can be integrated into this system or method in many elements or steps of this disclosure.

“Downline” refers to the recruits the MLM distributors can secure as participants in the MLM system. “Downline” can be integrated into this system or method in many elements or steps of this disclosure.

A “Product” refers to an article or substance that is manufactured or refined for sale. “Products” can be integrated into this system or method in many elements or steps of this disclosure.

A “Service” refers to a system supplying a public need such as transport, communications, or utilities such as electricity or water. For example, a “Service” may be an act of dealing with a customer in a store, restaurant, or hotel by taking their orders, showing, or selling them goods. Additionally, a “Service” may be work that someone does or time that someone spends working for an organization or a business that offers a particular type of help or work. A “Service” can be integrated into this system or method in many elements or steps of this disclosure.

“Network Marking” refers to a business model that depends on person-to-person sales by independent representatives, often working from home. For example, a “Network Marketing” business may require independent representatives to build a network of business partners or salespeople to assist with lead generation and closing sales. “Network Marketing” can be integrated into this system or method in many elements or steps of this disclosure.

A “Commission” refers to a payment to someone who sells goods directly related to the amount sold or a system that uses such payments. A “Commission” can be integrated into this system or method in many elements or steps of this disclosure.

“Commission Plan” refers to the decay rate of the commissions provided to the MLM system from the discount offered by the 3rd party; the 3rd party also selects the decay rate to calculate the commissions offered to the first purchaser as well as the percentage offered to the downline participants. The Commission Plan can refer to the payment structure for distribution of commission received for the selling of goods and/or services for the first purchaser as well as the downline participates. Therefore, a “Commission Plan” can be integrated into this system or method in many elements or steps of this disclosure.

“Commission Tree” refers to the payment structure in which commissions are given out. The Commission Tree can refer to the lineage of the first purchaser and the downline participants for the first purchaser. The Commission Tree can be a single line and/or the Commission Tree can have one or more branches as the downline participants recruit other downline participants. “Commission Tree” can be integrated into this system or method in many elements or steps of this disclosure.

“Advertise to the Network” refers to the advertisement provided to the MLM system from the 3^{rd} party offering a product, good, or service. “Advertise to the Network” can be integrated into this system or method in many elements or steps of this disclosure.

“Advertising Link” refers to a link that directs a consumer to a product, service, and/or good. The link can include a url code, a QR code, and/or any other suitable link to direct the consumer to the product, service, and/or good. “Advertising Link” can be integrated into this system or method in many elements or steps of this disclosure.

“Social media plug-ins for enhanced marketing” refer to sharing content with other people through social media platforms, for example, a share or like button. In some examples, the Social media plug-ins for enhanced marketing can include the Advertising Link. “Social media plug-ins for enhanced marketing” can be integrated into this system or method in many elements or steps of this disclosure.

“Local media (videos, pictures, text, sounds/haptics, other local media) online product descriptions for enhanced marketing” refer to various types of media, such as photos, videos, etc. “Local media (video's, pictures, text, sounds/haptics, other local media) online product descriptions for enhanced marketing” can be integrated into this system or method in many elements or steps of this disclosure.

“End of life of MLM tree” refers to the end of the MLM tree in which further participants in the MLM do not receive a commission, the commission tree starts up again, or the commission tree is restructured in some form. In at least one example, the further upline participants do not receive a commission. In some examples, the further downline participants do not receive a commission. “End of life of MLM tree” can be integrated into this system or method in many elements or steps of this disclosure. “Rating and recommendation modules” refer to modules in which a company, entity, or person provides ratings and/or recommendations for products, goods, or services. “Rating and recommendation modules” can be integrated into this system or method in many elements or steps of this disclosure.

“Existing MLM system” refer to currently existing or established companies that use the sales strategies to encourage existing distributors to recruit new distributors who are paid a percentage of their recruits'sales. “Existing MLM system” can be integrated into this system or method in many elements or steps of this disclosure.

“As seen on TV sales” refer to a generic nameplate for products advertised on television in the United States for direct-response mail-order through a toll-free telephone number. “As seen on TV sales” can be integrated into this system or method in many elements or steps of this disclosure.

A “Franchise” refers to an authorization granted by a government or company to an individual or group enabling them to carry out specified commercial activities, e.g., providing a broadcasting service or acting as an agent for a company's products.

“Franchise” can be integrated into this system or method in many elements or steps of this disclosure.

“Product consumables” refer to goods by individuals and businesses that must be replaced regularly because they wear out or are used up. “Product consumables” can be integrated into this system or method in many elements or steps of this disclosure.

“Service networks” refer to a collection of people and information brought together on the internet to provide a specific service or achieve a common business objective, such as Angie's List. “Service networks” can be integrated into this system or method in many elements or steps of this disclosure.

“Downlines tree goes across country boundaries” refers to the ability to pay out commissions for an MLM tree even though the participants in the MLM tree may not reside in the same country. In this case, the commissions would need to be calculated for the appropriate exchange rate to ensure participants are paid in their countries'currency in the correct amount. “Downlines tree goes across country boundaries” can be integrated into this system or method in many elements or steps of this disclosure.

“ID Enrollment” refers to a participant enrolling in an MLM product tree through an ID unique to each participant in the MLM system, which may correspond to a unique code that can be embedded in a link to a particular website, web page, or web application. A new user (e.g., user not found in current database records) may be introduced to the current user structure when the new user selects a coded link into which a unique code associated with a set of one or more upline users has been embedded. The new user may be automatically assigned a new code, which is further associated with the set of upline users. Thus, use of an embedded link that includes the new code may be associated with the new user and their set of upline users. “ID Enrollment” can be integrated into this system or method in many elements or steps of this disclosure.

“Track profits and payments” refers to the MLM system tracking the profits of the MLM and tracking the payments or commissions paid out to participants. “Track profits and payments” can be integrated into this system or method in many elements or steps of this disclosure.

“Track taxes” refers to tracking the commissions provided to participants for tax purposes. “Track taxes” can be integrated into this system or method in many elements or steps of this disclosure.

“Communicate events with downlines and uplines” refers to advertising events to participants in an MLM system. “Communicate events with downlines and uplines” can be integrated into this system or method in many elements or steps of this disclosure. “Product returns” refer to a process in which a customer or consumer takes previously purchased product, merchandise, or goods back to the retailer, and in turn, receive a refund in the original form of payment, exchange for another item (identical or different), or store credit. “Product returns” can be integrated into this system or method in many elements or steps of this disclosure.

“Product discounts” refer to a reduced price or something being sold at a price lower than that item is normally sold for. It is a reduction to a basic price for a good or service. “Product Discounts” can be integrated into this system or method in many elements or steps of this disclosure.

A “Credit card system” refers to a system that allows cardholders to borrow funds with which to pay for goods and services with the condition that the cardholders pay back the borrowed funds, plus interest, as well as any additional agreed-upon charges. A “Credit card system” can be integrated into this system or method in many elements or steps of this disclosure.

An “E-commerce sale” refers to sales of goods and services where the business occurs over the internet, an extranet, Electronic Data Interchange (EDI), or other online systems. Payment may or may not be made online. Business in this context is defined as an order placed by the buyer or price and terms of sale negotiated. An “E-commerce sale” can be integrated into this system or method in many elements or steps of this disclosure.

An “E-commerce shopping cart” refers to E-commerce software used to assist visitors in making purchases online. Upon checkout, the software calculates the order's total, including shipping and handling, taxes, and other parameters the site owner has previously set. An “E-commerce shopping cart” can be integrated into this system or method in many elements or steps of this disclosure.

A “Retailer” refers to a person or business that sells goods to the public in relatively small quantities for use or consumption rather than for resale. A “Retailer” can be integrated into this system or method in many elements or steps of this disclosure.

“Dynamic incentives and rewards for a product” refer to incentives or rewards that are continuously updated for a product. “Dynamic incentives and rewards for product” can be integrated into this system or method in many elements or steps of this disclosure.

“Suggestive selling” refers to a sales technique where an employee asks a customer if they would like to include an additional purchase and/or recommends a product that might suit the client. “Suggestive selling” can be integrated into this system or method in many elements or steps of this disclosure.

“Data security” refers to the process of protecting data from unauthorized access and data corruption throughout its lifecycle. “Data security” includes data encryption, tokenization, and key management practices that protect data across all applications and platforms.

“Data security” can be integrated into this system or method in many elements or steps of this disclosure.

“Banking referral” refers to a structured flow of collecting and organizing referrals for banks. Businesses who have been unsuccessful in a credit application process with a bank will be asked for their permission to have their financial information passed to designated finance platforms that can contact the business in a regulated time frame. “Banking referral” can be integrated into this system or method in many elements or steps of this disclosure.

“Marketing materials” refer to a means of marketing, advertising, and/or promotional materials developed by or for a license (or subject to licensee's approval) that promote the sale of the licensed product, including but not limited to television, radio, and online advertising, point of sale materials (e.g., posters, counter-cards), packaging advertising, print media and all audio or video media. “Marketing materials” can be integrated into this system or method in many elements or steps of this disclosure.

A “Lottery” refers to a process or thing whose success or outcome is governed by chance. A means of raising money by selling number tickets and giving prizes to the holders of the number(s) drawn at random. A “Lottery” can be integrated into this system or method in many elements or steps of this disclosure.

“Freelancers” refer to a person who works selling work or services by the hour, day, job, etc. (e.g., as a writer, designer, performer, or the like), rather than working on a regular salary basis for one employer. “Freelancers” can be integrated into this system or method in many elements or steps of this disclosure.

“MLM Algorithm” refers to the calculation performed using the compensation decay rate to calculate the commissions for downline participants in the Commission Tree. “MLM Algorithm” can be integrated into this system or method in many elements or steps of this disclosure.

“Large Box Stores” refer to a physically large retail establishment; usually, part of a chain of stores offers various products to its customers. The term sometimes refers, by extension, to the company that operates the store and might be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance. “Large Box Stores” can be integrated into this system or method in many elements or steps of this disclosure.

“Airline sky miles” refer to a loyalty program offered by airlines and/or credit cards.

Typically, consumers accumulate a set amount of miles based on how much is spent on a ticket or a credit card and are also known as frequent flyer miles or travel points. “Airline sky miles” can be integrated into this system or method in many elements or steps of this disclosure.

“Social media aggregators” refers to a tool that allows a person to collate posts and updates from different social media feeds. It creates an organized view of social posts on a specific topic and displays user-generated content on live social walls. “Social media aggregators” can be integrated into this system or method in many elements or steps of this disclosure. “Connect App Store” refers to connecting the app store to an MLM system. “Connect App Store” can be integrated into this system or method in many elements or steps of this disclosure.

Some embodiments of this disclosure, illustrating all its features, will now be discussed in detail. The words “comprising,” “having,” “containing,” and “including,” and other forms thereof are intended to be equivalent in meaning and be open-ended in that an item or items following any one of these words is not meant to be an exhaustive listing of such item or items or meant to be limited to only the listed item or items.

Currently, to join an MLM, there is an initiation fee, which is a barrier against those who just wish to refer a single product they like.

Current multi-level marketing (MLM) systems do not take full advantage of the internet and how consumers can influence other consumers to make purchases.

Also, current MLM systems do not incorporate incentivizing users of a multi-level marketing system by offering a dynamic commission tree.

In addition, there is no current MLM system that utilizes the money or funds dedicated to discounts or coupons to be reincorporated into a multi-level marketing system to incentivize consumers to make purchases and advertise the product they purchased.

MLMs are not designed to distribute intangible goods, such as entry into games of chance. Nor are MLMs designed to handle multiple quick purchases, each of which may have a different value and upline, such as multiple wagers in a quick game of blackjack or poker. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

This system comprises of an Admin Network Computer 102 which includes and/or is operable to perform the methods or instructions corresponding to a Base Module 104, Calculation Module 106, Commission Module 108, Advertising Module 110, Admin Database 112, Vendor Module 114, Compensation Database 116, and a Code Database 118. The Admin Network computer 102 can include the MLM system to accept sellers (3rd parties) and create a “single product tree” multi-level marketing method is formed. The multi-level marketing method can include the steps of providing at least one product, providing an MLM system with a seller's commission structure, providing at least one seller of a product with its associated commission structure, providing a plurality of buyers/distributors, allowing the at least one first seller to enroll an at least one product to the MLM system, allowing at least a first buyer/distributor to purchase the at least one product, allowing the at least the first buyer/distributor to advertise the at least one product to other potential buyers/distributors, and allowing at least a second buyer/distributor to buy the advertised product, and-wherein, the seller sets a commission structure for a product, enrolls the product into the MLM system, allowing the first-, second and so on purchasers/distributors to purchase and then advertise the product, and allowing the purchasers/distributors to receive a commission based upon the seller's product commission structure. providing at least one product, associated with a seller's commission structure, and enrolling it into the MLM system. Potential buyers/distributors can then purchase the product, advertise it to other potential purchasers/distributors, and receive a commission based on the seller's product commission structure. The first buyer/distributor will be followed by second, third and so on purchasers/distributors.

An Admin Network Base Module 104 connects to the 3rd Party Base Module 136 to connect the Admin Network Computer 102 with the 3rd Party Network Device 132. The Admin Network Base Module 104 is operable to initiate the Vendor Module 114, and initiate the Calculation Module 106. The 3rd Party Network Device 132 is operable to interact with the sellers via the 3rd Party Network Base Module 136, and the Admin Network Vendor Module 114 can be the module loaded on the seller's computer system.

An Admin Network Calculation Module 106, which is initiated by the Admin Network Base Module 104, is operable to extract the discount received from the 3rd Party Module 136 as well as the compensation plan (e.g., its decay rate or commission structure so that each downline gets less and less commission) to determine the commissions for the MLM (Multi-Level Marketing) tree and stores the data in the Admin Network Compensation Database 116.

An Admin Network Commission Module 108 is continuously polling for the user data (the user being the product purchaser/distributor) from the 3rd Party Discount Module 140 and/or from the Gambling Network Wager Module 148. Once the Admin Network Commission Module 108 receives the user data, the Admin Network Commission Module 108 uses the data stored in the Admin Network Compensation Database 116 to determine the downline and upline commissions for the other users (product purchasers/distributors) within the MLM tree. It then initiates the Admin Network Advertising Module 110.

An Admin Network Advertising Module 110, which is initiated by the Admin Network Commission Module 108, determines the user's (product purchasers/distributors) sphere of influence or contact list to provide the user's potential downline purchasers/distributors with a link and/or a code for the potential downline purchasers/distributors to become part of the MLM tree of the user.

An Admin Network Admin Database 112, which is created through the Admin Network Vendor Module 114 (seller of a product), contains the data received from various 3rd Parties (various sellers) that are part of the MLM, the data may contain an item ID, description of the item, the original cost of the item, the discount for the item, the cost of the item with the discount, the compensation plan decay rate and a link to the item.

An Admin Network Vendor (those selling products) Module 114, which is initiated by the Admin Network Base Module 104, receives the data from the 3rd Party Network 132, stores the data in the Admin Network Admin Database 112, creates a link for the item, and sends the link back to the 3rd Party Network 132, and returns to the Admin Network Base Module 104.

An Admin Network Compensation Database 116 is created through the Admin Network Calculation Module 106 and contains the various commissions for the different product purchasers/distributors.

An Admin Network Code Database 118 contains the links and/or codes given to the product purchasers/distributors (users) for the product purchasers/distributors (user) to pass the code to their potential purchasers/distributors to advertise or promote the item the user has purchased.

The Cloud 124 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the internet, and relies on sharing resources to achieve coherence and economies of scale like a public utility. At the same time, third-party clouds enable organizations to focus on their core businesses instead of expending resources on computer infrastructure and maintenance. In at least one example, the Admin Computer Network 102, the User Device 126, the 3rd Party Network Device 136, and/or the Card Network Device 148 can be communicably connected via the Cloud 124.

A User (product purchasers/distributors) Device 126 can include devices such as laptops, smartphones, tablets, computers, and/or smart speakers.

The User Device Comms 128 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and/or other suitable communication techniques. The communication network may allow ubiquitous access to shared pools of configurable system resources and higher-level services that can be rapidly provisioned with minimal management effort, often over the internet, and rely on sharing resources to achieve coherence and economies of scale in a public utility. At the same time, third-party clouds enable organizations to focus on their core businesses instead of expending resources on computer infrastructure and maintenance.

A User Device Control Module 130, which connects to the 3rd Party Network 136, allows a purchaser/distributor to select an item and the associated link, determines if the purchaser/distributor entered a code, and sends the link and code, if available, to the 3rd Party Network 136.

A User Device User Database 132 which contains the user's (product purchasers/distributors) followers (sphere of influence) as well as the followers'contact information in order for them to receive commissions on their purchases.

A User Device Downline Module 134, which is continuously polling to receive the code and link from the Admin Network Advertising Module 110 to allow the purchaser/distributor to pass the code and link to the user's followers stored in the User Device User Database 132.

A 3rd Party Network 136, which is the various 3rd Parties, such as retail stores, services, or e-commerce sites that offer items to users at a discount in order to use MLM.

The 3rd Party Network Comms 138 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and/or other suitable communication techniques. The communication network may allow ubiquitous access to shared pools of configurable system resources and higher-level services that can be rapidly provisioned with minimal management effort, often over the internet, and relies on sharing resources to achieve coherence and economies of scale like a public utility. At the same time, third-party clouds enable organizations to focus on their core businesses instead of expending resources on computer infrastructure and maintenance.

A 3rd Party Base Module 140, which initiates the 3rd Party Admin Module 138, continuously polls for the user to select a link, receives the purchaser/distributor data, and initiates the 3rd Party Network Discount Module 144.

A 3rd Party Network Admin Module 142, which is initiated from the 3rd Party Network Base Module 136, connects to the Admin Network 102, sends the data for the items to be purchased, receives a link from the Admin Network 102, stores the link in the 3rd Party Network Database 142 and/or returns to the 3rd Party Network Base Module 136.

A 3rd Party Network Discount Module 144, which is initiated from the 3rd Party Base Module 140, extracts the link and/or code, compares the link and/or code to the 3rd Party Network 3rd Party Database 146 to extract the corresponding discount for the selected item so that the discount is applied to the user order. The 3rd Party network discount module 144 can determine if the user entered a code or not, cause the order to be processed where the process returns to the 3rd Party Network Base Module 136.

A 3rd Party Network 3rd Party Database 146 contains information about the item the 3rd party selects to offer at a discount for the Admin Network 102.

A Card Network 148 may be a computer or group of computers that sends and receives data and performs operations related to the use of a card. The card may be a credit card, debit card, membership card, loyalty card, rewards card, gift card, or any other type of card used to purchase a product. The card may be an all-in-one card which may act as any combination of cards. For example, the card may be a debit card that also gives a reward or discount at some stores or on some products. The card may be programmable such that the card may contain dynamic information or may provide a link to a place where information can be edited.

A Card Network Code to Coupon Module 150, which may connect to the Admin Network 102 and retrieve referral codes from the Admin Network Code Database 118. The Card Network Code to Coupon Module may then create an entry in the Card Network Card Rewards Database 152, which has a generated coupon code and the discount associated with the referral code. The generated coupon code is then sent back to the Admin Network 102 and stored in the Admin Network Coupon Database 122.

A Card Network Card Rewards Database 152 which may contain coupons, points, credit, or any other rewards which may be used in purchasing a product. These rewards are associated with a card and with a product or vendor. When the card is used to purchase the product or from the vendor, the user may be able to apply the rewards stored in this database.

A Card Network Card Management App 154 which may be an application that allows a cardholder to manage the rewards stored on a card. For example, a cardholder may use the application to add or remove coupons from the card, add a loyalty program to the card, manage the balance of credit on the card, and put points or pre-paid currency onto the card, etc.

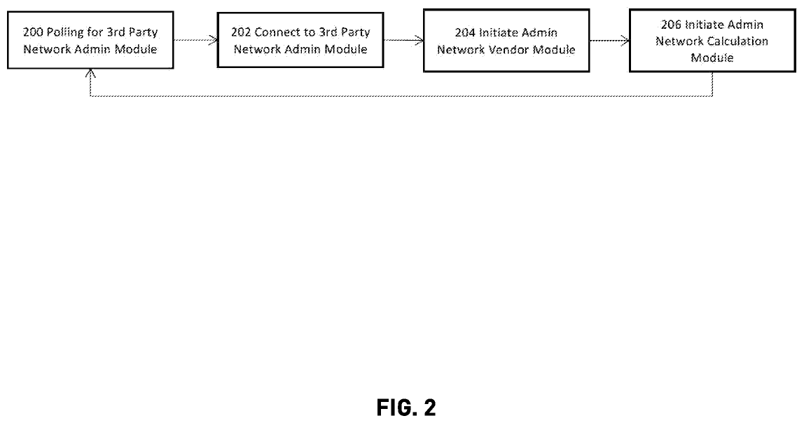

Functioning of the “Base Module” 104 of the Admin Network Computer 102 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 displays the method for the “Admin Network Base Module 104.” The process begins with the Admin Network Base Module 104 continuously polls for the 3rd Party Network Admin Module 138 (sellers of products) at step 200. The Admin Network Base Module 104 connects to the 3rd Party Network Admin Module 138 (sellers of products) at step 202. Once the Admin Network Base Module 104 connects to the 3rd Party Network Admin Module 138, the Admin Network Base Module 104 initiates the Admin Network Vendor Module 114 at step 204. Then the Admin Network Base Module 104 initiates the Admin Network Calculation Module 106, and the process returns to step 200, at step 206.

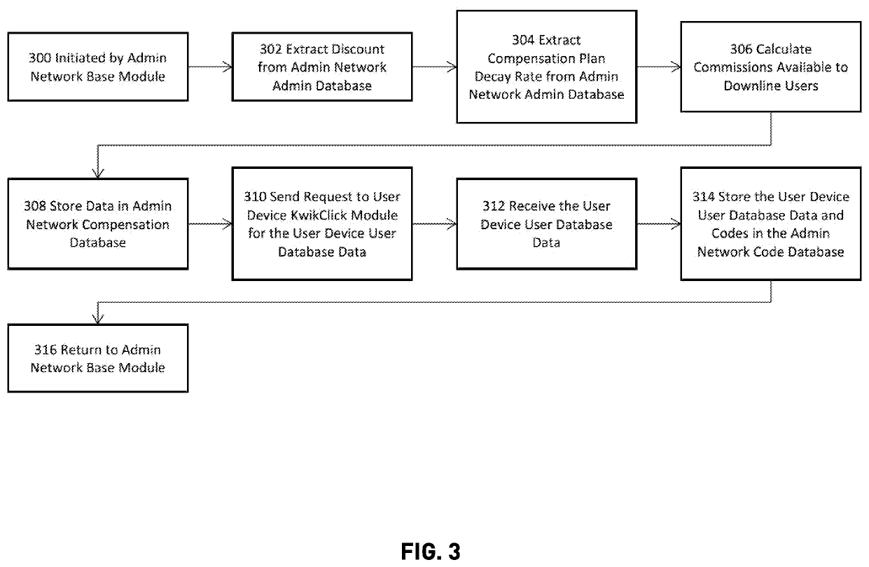

Functioning of the “Calculation Module 106 of the Admin Network Computer 102” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

Functioning of the “Calculation Module” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 displays the method for the Admin Network Calculation Module 106 according to some aspects of the disclosure. The process begins with the Admin Network Base Module 104 initiating the Admin Network Calculation Module 106 at step 300. The Admin Network Calculation Module 106 extracts the discount from the Admin Network Admin Database 112, which is received from the 3rd Party Network 136, at step 302. Then the Admin Network Calculation Module 106 extracts the compensation plan decay rate from the Admin Network Admin Database 112, at step 304. The Admin Network Calculation Module 106 determines the commissions available to the downline users or the user's followers who purchased the item. In some embodiments, the commissions may be calculated by using the discount on the item and providing 50% of the discount to the first participant and then the remaining amount of the discount for the downline users at a 50% decay rate. For example, if the first user purchased an item that was originally $59.00 discounted by 15%, the first user to make the purchase would receive $3.32 or 50% of the discount. Then any downline user of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device Control Module 130 for the data stored in the User Device User Database 132, at step 310. Then the Admin Network Calculation Module 106 receives the User Device User Database 132 data from the User Device Control Module 130, at step 312. The Admin Network Calculation Module 106 stores the received data, as well as the code data, in the Admin Network Code Database 118, at step 314. The Admin Network Calculation Module 106 then returns to the Admin Network Base Module 104, at step 316.

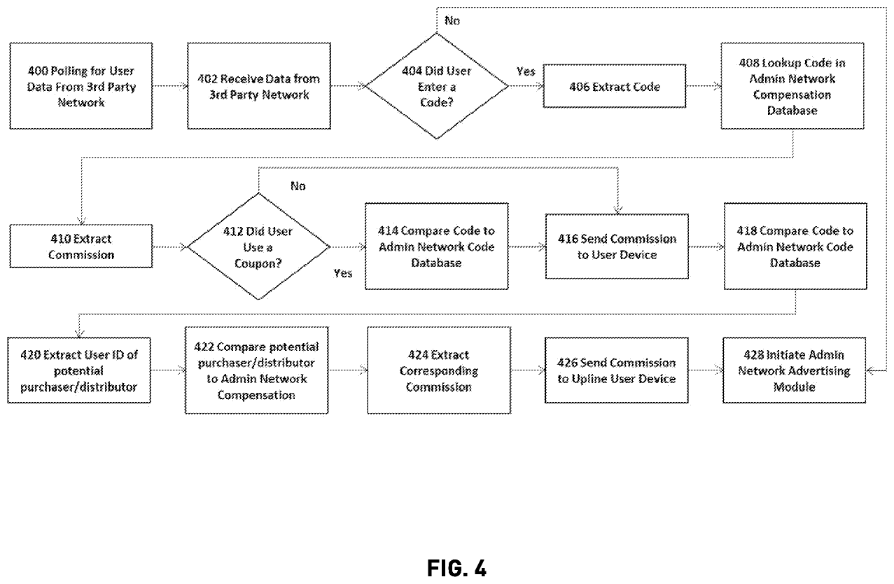

Functioning of the Commission Module 108 of the Admin Network Computer 102 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. FIG. 4 displays the method for the Admin Network Commission Module 108, according to some aspects of the disclosure. The process begins with the Admin Network Commission Module 108 continuously polling for the user data from the 3rd Party Network Discount Module 144, at step 400. The Admin Network Commission Module 108 receives the user data from the 3rd Party Network Discount Module 144, at step 402. Then the Admin Network Commission Module 108 determines if the user entered a code at step 404. If the user did enter a code, the Admin Network Commission Module 108 extracts the code the user entered at step 406. The extracted code is then looked up in the Admin Network Compensation Database 116, which contains the various commissions for the different sphere of influence or potential product purchasers/distributors levels and the associated code for each sphere of influence levels step 408. Then the Admin Network Commission Module 108 extracts the corresponding commission for the code looked up in the Admin Network Compensation Database 116, at step 410. The Admin Network Commission Module 108 determines if the user used a coupon. The user data associated with the purchase may contain a coupon code or other data that identifies the use of a coupon. If the user did not use a coupon, the Admin Network Commission Module 108 may skip to step 416, at step 412. The Admin Network Commission Module 108 sends the coupon data to the Admin Network Coupon Module 120 and polls for a response. The response from the Admin Network Coupon Module 120 may contain alterations to the commission plan, which the Admin Network Commission Module 108 may then apply to the extracted commission at step 414. The Admin Network Commission Module 108 sends the commission to the user (purchaser/distributor) at step 416. Then the Admin Network Commission Module 108 compares the extracted code to the Admin Network Code Database 118, which contains the list of users and the code sent to the user's downline users, at step 418. The Admin Network Commission Module 108 extracts the user ID and sphere of influence or potential purchaser/distributor by using the extracted code at step 420. Then the Admin Network Commission Module 108 compares the extracted sphere of influence or potential purchaser/distributor to the Admin Network Compensation Database 116, at step 422. The Admin Network Commission Module 108 uses the extracted sphere of influence to extract the corresponding commission from the Admin Network Compensation Database 116, at step 424. The Admin Network Commission Module 108 sends the commission to the upline user at step 426. If the user did not enter a code, the Admin Network Commission Module 108 initiates the Admin Network Advertising Module 110, at step 428.

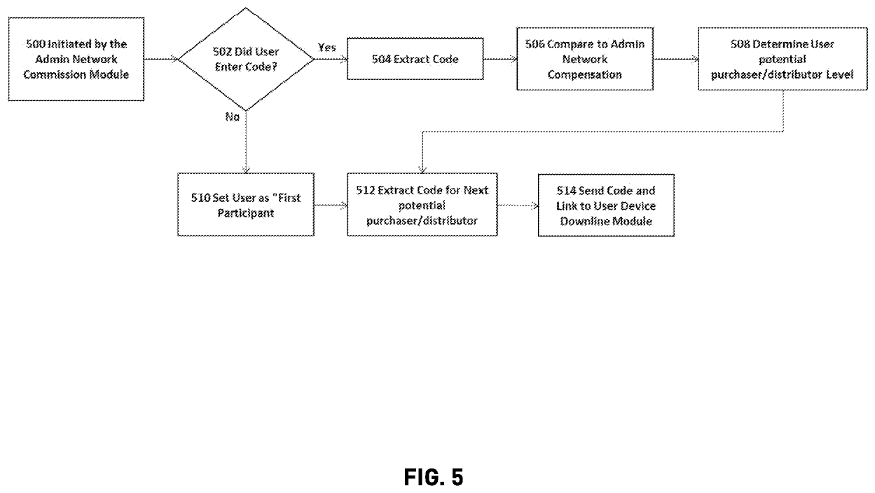

Functioning of the Advertising Module 110 of the admin network computer 102 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5. displays the method for the Admin Network Advertising Module, according to some aspects of the disclosure. The process begins with the Admin Network Commission Module 108, initiating the Admin Network Advertising Module 110 at step 500. The Admin Network Advertising Module 110 determines if the user entered a code at step 502.

Suppose it is determined that the user entered a code the code is extracted, at step 504. The Admin Network Advertising Module 110 compares the extracted code to the Admin Network Compensation Database 116, at step 506. The Admin Network Advertising Module 110 determines the user's sphere of influence level at step 508. If it is determined that the user did not enter a code, then the Admin Network Advertising Module 110 sets the user as the “First Participant” at step 510. Then the Admin Network Advertising Module 110 extracts the code for the next sphere of influence level or potential purchaser/distributor in order to provide the user's downline users with a code that would allow them to join the Multi-Level Marketing tree, at step 512. The Admin Network Advertising Module 110 sends code and the link to the item to the User Device Downline Module 134, at step 514.

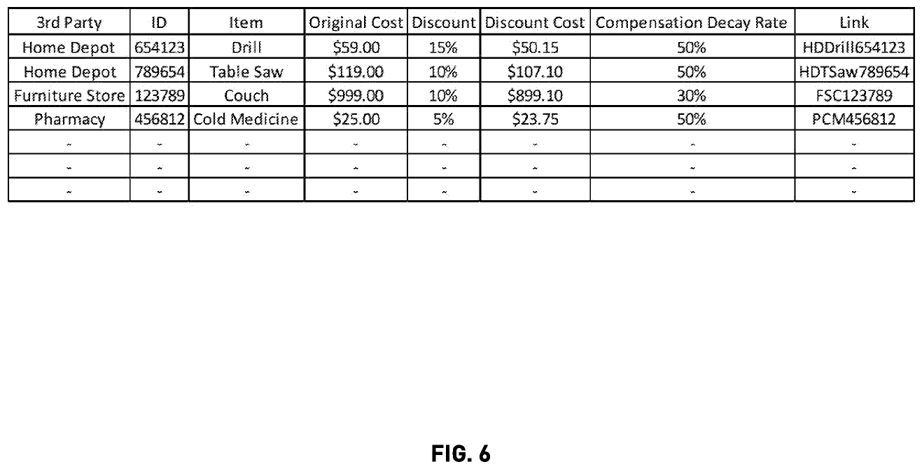

Functioning of the Admin Database 112 of the admin network computer 102 will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

Functioning of the “Admin Database” will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 6 displays the Admin Network Admin Database 112, which is created through the Admin Network Vendor Module 114. The Admin Network Vendor Module 114 receives the item data from the 3rd Party Network, creates a link for the item, stores the data in the Admin Network Admin Database 112, and/or sends the created link back to the 3rd Party Network. The Admin Network Admin Database 112 contains the data collected from various 3rd Parties enrolled in the Multi-Level Marketing System. The Admin Network Admin Database 112 contains the name of the 3rd party, the ID for the item, a description of the item, the original cost of the item, the discount provided by the 3rd party, the cost of the item with the discount, the compensation decay rate or how the downline commissions are calculated, and/or the link to the item.

Functioning of the Vendor Module 114 of the admin network computer 102 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

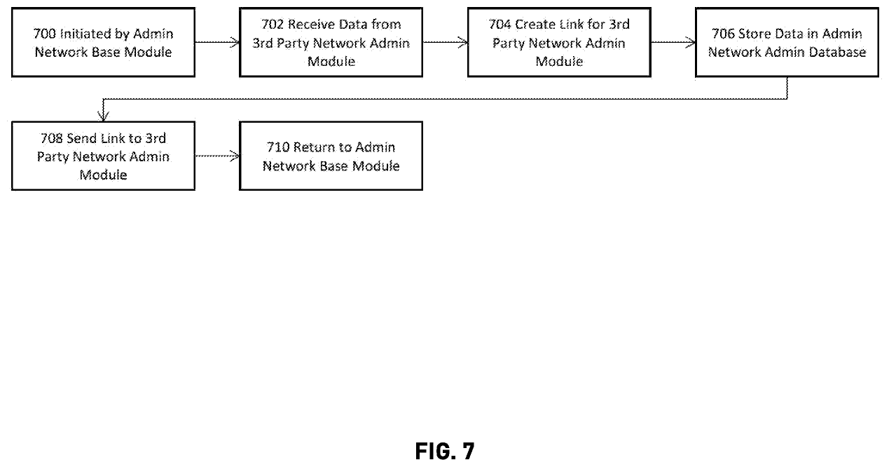

FIG. 7. displays the method for the Admin Network Vendor Module 114 according to some aspects of the disclosure. The process begins with the Admin Network Base Module 104 initiating the Admin Network Vendor Module 114 at step 700. The Admin Network Vendor Module 114 receives the data from the 3rd Party Network Admin Module 142, which may include the item to be enrolled in the MLM system, the original cost of the item, the discount provided by the 3rd party, the cost of the item with the discount, the compensation plan decay rate, etc., at step 702. Then the Admin Network Vendor Module 114 creates a link for the item for the 3rd Party Network Admin Module 142. A vendor is a seller of a product, such as a retailer, at step 704. The Admin Network Vendor Module 114 stores the received data and the created link in the Admin Network Admin Database 112, at step 706. The Admin Network Vendor Module 114 sends the link to the 3rd Party Network Admin Module 142 at step 708. The Admin Network Vendor Module 114 returns to the Admin Network Base Module 104 at step 710.

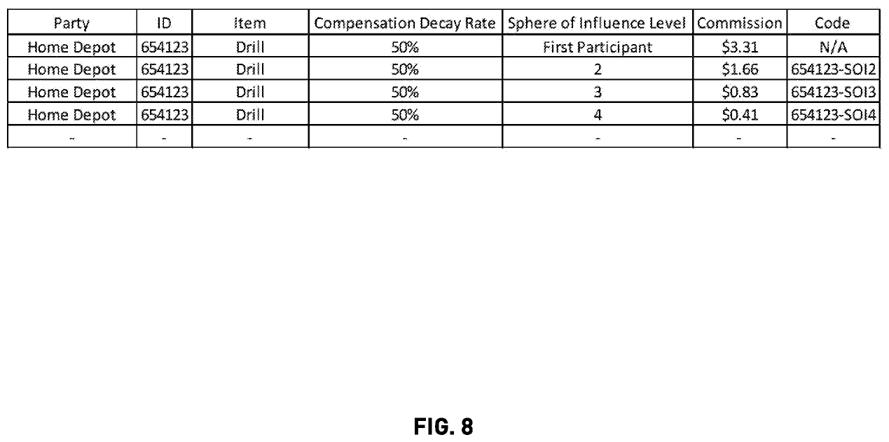

Functioning of the Compensation Database 116 of the admin network computer 102 will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

Functioning of the Compensation Database 116 will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 8. displays the Admin Network Compensation Database 116, which is created through the Admin Network Calculation Module 106. The Admin Network Calculation Module 106 extracts the discount and the compensation plan decay rate to calculate the downline commissions for additional users to be added to the downline commission tree, and the various sphere of influence levels stored in the Admin Network Compensation Database 116. The Admin Network Compensation Database 116 contains the 3rd party, the ID for the item, the item, the compensation plan decay rate, the various sphere of influence levels, the commission for each sphere of influence level, and the code to be used by the user's downline users to enroll in the MLM system.

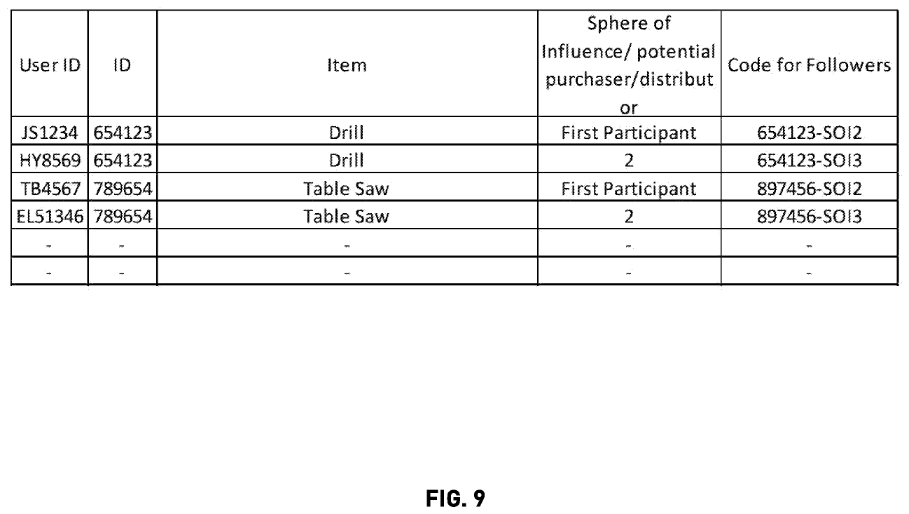

Functioning of the Code Database 118 of the admin network computer 102 will now be explained with reference to FIG. 9. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

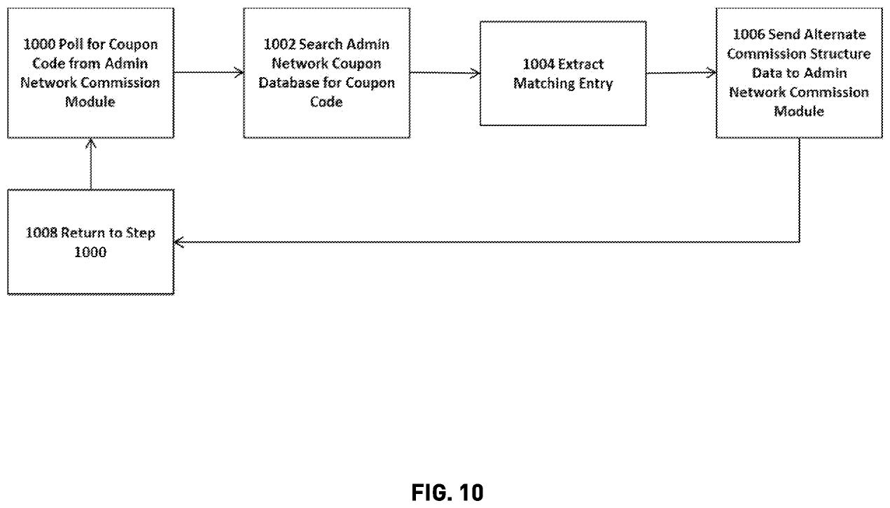

FIG. 9 displays the Admin Network Code Database 118, which is used to determine the sphere of influence of the purchaser/distributor from the code that was used when a purchaser/distributor purchased a product or item from a 3rd Party, according to some aspects of the disclosure. The Admin Network Code Database 118 contains a User ID, ID, Item, Sphere of Influence/potential purchaser/distributor, and Code for downline users. Functioning of the Coupon Module 120 of the admin network computer 102 will now be explained with reference to FIG. 10. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 10 displays the method for the Admin Network Coupon Module 120, according to some aspects of the disclosure. The process begins with the Admin Network Coupon Module 120 polling for a coupon code from the Admin Network Commission Module 108. The coupon code may correspond to a coupon used by a user to purchase a product registered with the network at step 1000. The Admin Network Coupon Module 120 may search the Admin Network Coupon Database 122 for the received coupon code at step 1002. The Admin Network Coupon Module 120 may extract the entry that matches the received coupon code at step 1004. The Admin Network Coupon Module 120 sends the extracted data, which contains alternate commission structure information, to the Admin Network Commission Module 108, at step 1006. The Admin Network Coupon Module 120 returns to polling for a coupon code from the Admin Network Commission Module 108, at step 1008.

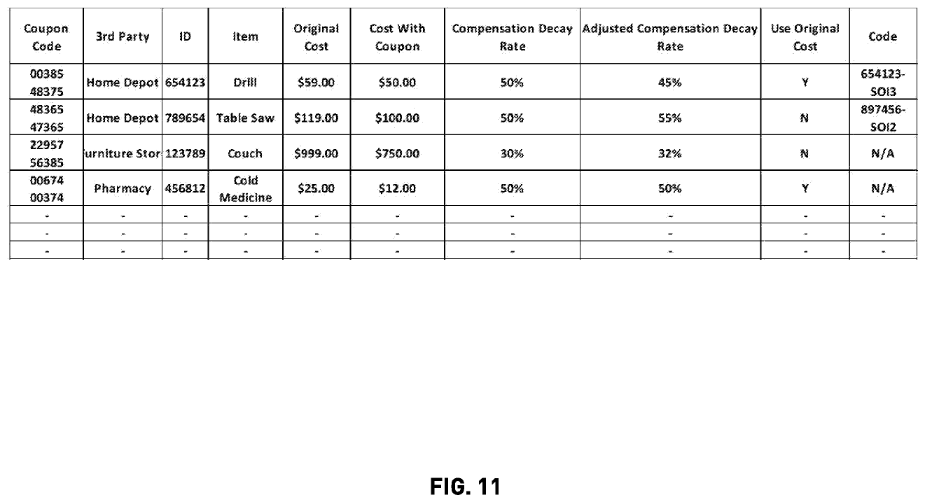

Functioning of the Coupon Database 122 will now be explained with reference to FIG. 11. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 11 displays the Admin Network Coupon Database 122 according to some aspects of the disclosure. The Admin Network Coupon Database 122 may contain a list of coupon codes and the associated changes to a commission structure. The database may contain identifiers for the product the coupon code is associated with, such as an item ID or item name. The database may contain the original decay rate for commission and an altered rate. The database may also indicate whether the original cost of the product or the discounted cost with the coupon should be used to calculate commission. Coupons generated by the Card Network Code to Coupon Module 150 may be associated with the original code used to generate them.

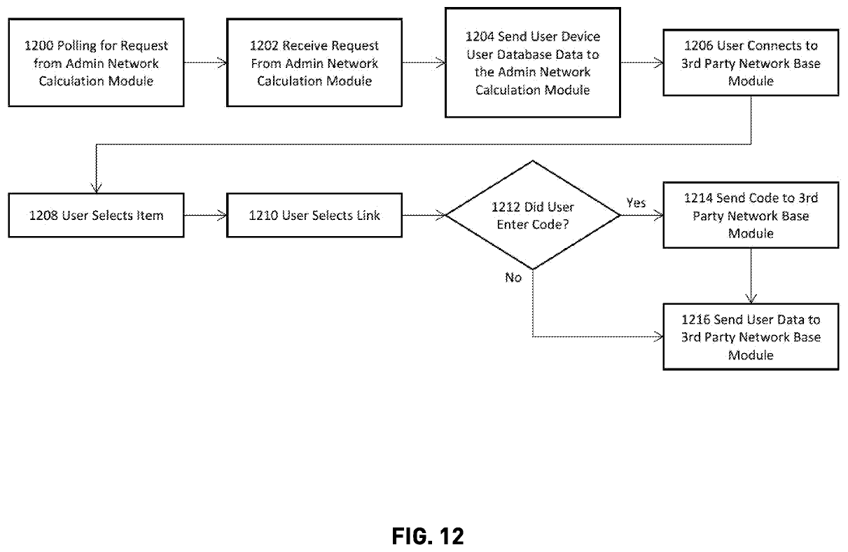

Functioning of the Control module 130 will now be explained with reference to FIG. 12. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 12 displays the method for the User Device control module 130 of the User device 126 according to some aspects of the disclosure. The process begins with the User Device control module 130 continuously polling for a request from the Admin Network Calculation Module 106 for the User Device User Database 132 data, at step 1000. The User Device KwikClick Module 130 receives a request from the Admin Network Calculation Module 106 for the User Device User Database 132 data, at step 1002. Then the User Device control module 1300 sends the User Database 132 data to the Admin Network Calculation Module 106, at step 1004. The User Device control module 130 connects to the 3rd Party Network Base Module 136, at step 1006. Then the user selects an item from the 3rd Party Network 136, at step 1008. The user selects the link from the 3rd Party Network 136, at step 1010. Then the User Device control module 130 determines if the user entered a code. If not, the process continues to step 1010, at step 1012. If it is determined the user entered a code, the User Device control module 130 sends the code to the 3rd Party Network Base Module 136, at step 1014. The User Device control module 130 sends the user data to the 3rd Party Network Base Module 136. In some embodiments, the user data may be to purchase the item, such as name, address, billing information, etc., at step 1016.

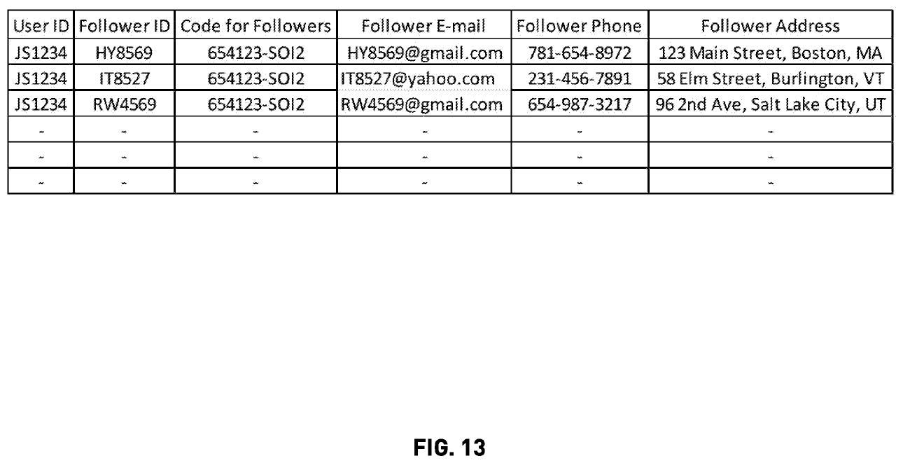

Functioning of the User Database 132 of the User device 126 will now be explained with reference to FIG. 13. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 13 displays the User Device User Database 132, which contains the user's downline users as well as the downline users'information. The User Device User Database 132 contains the user's ID, the downline users'user's ID, the code provided to the downline users, the downline user's e-mail address, the downline users'phone number, the downline users'address. In some embodiments, the User Device User Database 132 may contain the downline users'social media information such as Twitter, Instagram, Facebook, etc. In some embodiments, the User Device User Database 132 may contain payment information such as bank accounts, credit card information, PayPal, Venmo, etc., element 1100.

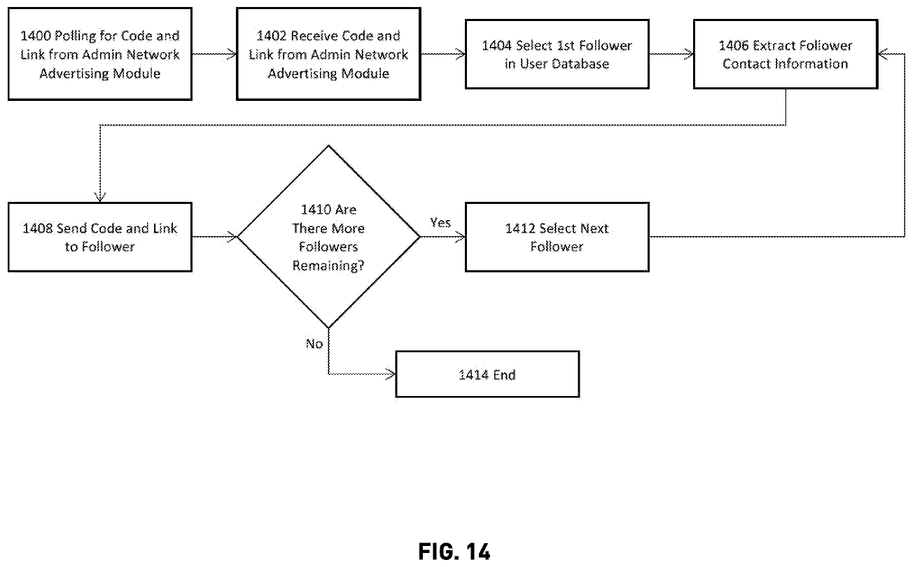

Functioning of the Downline Module 134 will now be explained with reference to FIG. 14. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 14 displays the method for the User Device Downline Module 134, according to some aspects of the disclosure. The process begins with the User Device Downline Module 134 continuously polling for the code and the link from the Admin Network Advertising Module 110, at step 1200. The User Device Downline Module 134 receives the code and the link from the Admin Network Advertising Module 110, at step 1202. The User Device Downline Module 134 selects the first downline user in the User Device User Database 132 at step 1204. The User Device Downline Module 134 extracts the downline users'contact information stored in the User Device User Database 132, at step 1206. Then the User Device Downline Module 134 sends the code and link to the follower's contact information. In some embodiments, the code and link may be shared on social media sites, such as Twitter, Instagram, Facebook, etc., for the user's downline users to receive the code and link at step 1208. The User Device Downline Module 134 determines if more downline users remain in the User Device User Database 132 at step 1210. If it is determined that there are more downline users stored in the User Device User Database, the User Device Downline Module 134 selects the next user stored in the User Device User Database 132, and the process returns to step 1206 at step 1212. If the User Device Downline Module 134 determines that no more downline users remain in the User Device User Database 132 then the process ends at step 1214.

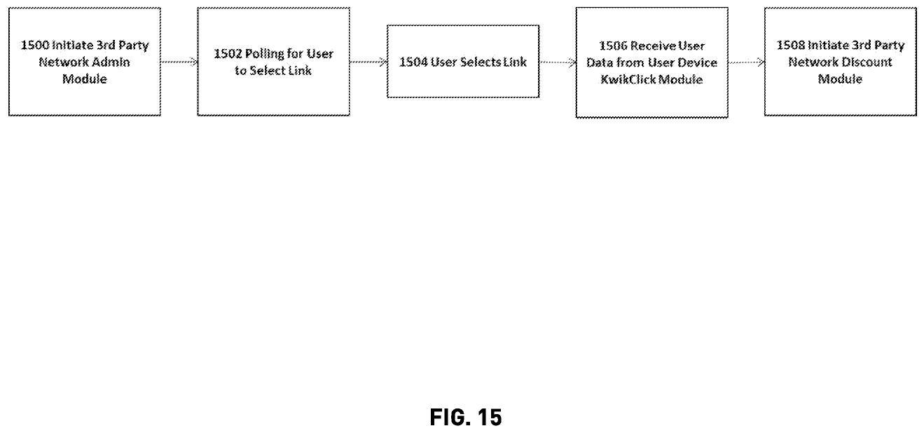

Functioning of the third party base module 140 will now be explained with reference to FIG. 15. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 15 displays the method for the third party base module 140 of the third 3rd party network 136, according to some aspects to the disclosure. The process begins with the 3rd Party Network Base Module 136 initiating the 3rd Party Network Admin Module 142, at step 1300. Then the 3rd Party Network Base Module 136 continuously polls for the user to select the link at step 1302. The user selects the link on the 3rd Party Network 136, at step 1304. Then the 3rd Party Network Base Module 136 receives the user data from the User Device control module 130. In some embodiments, the user data may be to purchase the item such as name, address, billing information, etc., at step 1306. Then the 3rd Party Network Base Module 136 initiates the 3rd Party Network Discount Module 144, at step 1308.

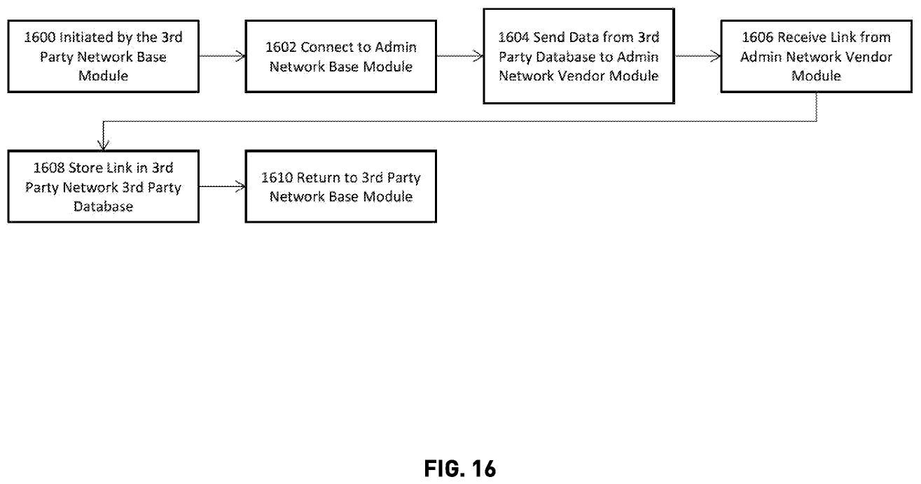

Functioning of the Admin Module 142 of the third 3rd party network 136 will now be explained with reference to FIG. 16. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 16 displays the method for the 3rd Party Network Admin Module according to some aspects of the disclosure. The process begins with the 3rd Party Network Admin Module 142 being initiated by the 3rd Party Network Base Module 136, at step 1400. The 3rd Party Network Admin Module 142 connects to the Admin Network 102 at step 1402. Then the 3rd Party Network Admin Module 142 sends the 3rd Party Network 3rd Party Database 146 to the Admin Network Vendor Module 114, at step 1404. The 3rd Party Network Admin Module 142 receives the link for the item from the Admin Network Vendor Module 114 at step 1406. Then the 3rd Party Network Admin Module 142 stores the link in the 3rd Party Network 3rd Party Database 146, at step 1408. Then the 3rd Party Network Admin Module 142 returns to the 3rd Party Network Base Module 136, at step 1410.

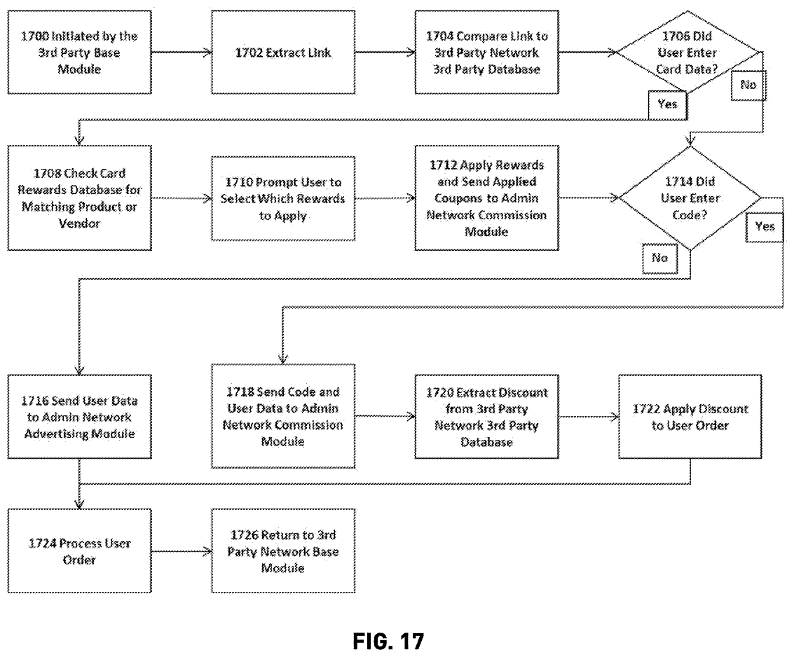

Functioning of the Discount Module 144 will now be explained with reference to FIG. 17. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 17 displays the method for the Discount Module, according to some aspects of the disclosure. The process begins with the 3rd Party Network Base Module 136 initiating the 3rd Party Network Discount Module 144, at step 1700. The 3rd Party Network Discount Module 144 extracts the link received from the user through the process described in the 3rd Party Network Base Module 136, at step 1702. Then the 3rd Party Network Discount Module 144 compares the extracted link to the 3rd Party Network 3rd Party Database 146, at step 1704. The 3rd Party Network Discount Module 144 determines if the user has entered card data. Card data is any data that may be associated with a card, such as a credit card number, card expiration date, CVC, data stored on the magnetic stripe of a card, or any other data that the user may submit to associate the purchase of the product with a card. If the user has not entered card data, the 3rd Party Network Discount Module 144 may skip to step 714 at step 1706. Then the 3rd Party Network Discount Module 144 connects to the Card Network 148 and accesses the Card Network Card Rewards Database 152. The 3rd Party Network Discount Module 144 searches for rewards in the database that would be applied to either the product being purchased, the vendor from which the product is being purchased or both. Some rewards may require that the product is purchased from only some vendors, some rewards may apply to the product despite the vendor, and some rewards may be applied to any purchase made from the vendor, at step 1708. The 3rd Party Network Discount Module 144 prompts the user to select which rewards to apply to this purchase. For example, the user may need to choose between a 10% discount or $5 off the purchase. The 3rd Party Network Discount Module 144 may default to whichever reward or combination of rewards gives the largest discount. This step may be skipped if none of the rewards are exclusive, at step 1710. Then the 3rd Party Network Discount Module 144 applies the rewards to the purchase and sends coupon data to the Admin Network Commission Module 108. Not all rewards may be coupons, but any reward may be considered a coupon. The 3rd Party Network Discount Module 144 may only send the coupon data to the Admin Network Commission Module 108 following completion of the purchase. Once the reward has been claimed, it may be erased from, or marked used in, the Card Network Card Rewards Database 152, at step 1712. The 3rd Party Network Discount Module 144 determines if the user entered a code. A user may have to select between using card rewards or entering a code if the two discounts are exclusive, at step 1714. If it is determined that the user did not enter a code, the 3rd Party Network Discount Module 144 sends the user data to the Admin Network Advertising Module 110, at step 1716. If it is determined that the user entered a code, the 3rd Party Network Discount Module 144 sends the code and the user data to the Admin Network Commission Module 108, at step 1718. The 3rd Party Network Discount Module 144 extracts the corresponding discount using the extracted link from the 3rd Party Network 3rd Party Database 146, at step 1720. Then the 3rd Party Network Discount Module 144 applies the extracted discount to the user's order, at step 1722. Then the 3rd Party Network Discount Module 144 processes the user's order at step 1724. Then the 3rd Party Network Discount Module 144 returns to the 3rd Party Network Base Module 136, at step 1726.

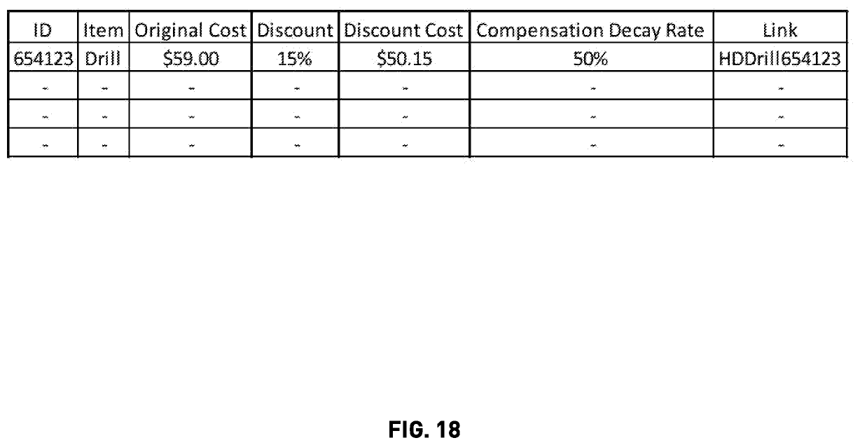

Functioning of the third Party Database 146 will now be explained with reference to FIG. 18. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 18 displays the 3rd party database of the 3rd Party Network, which contains the information about the items enrolled in the MLM system as well as the link created by the Admin Network Vendor Module 114. The 3rd Party Network 3rd Party Database 146 contains the item ID, the item, the original cost of the item, the discount provided by the 3rd party for the item, the cost of the item with the discount, the compensation plan decay rate which the 3rd party enters, and the link received from the Admin Network Vendor Module 114, element 1600.

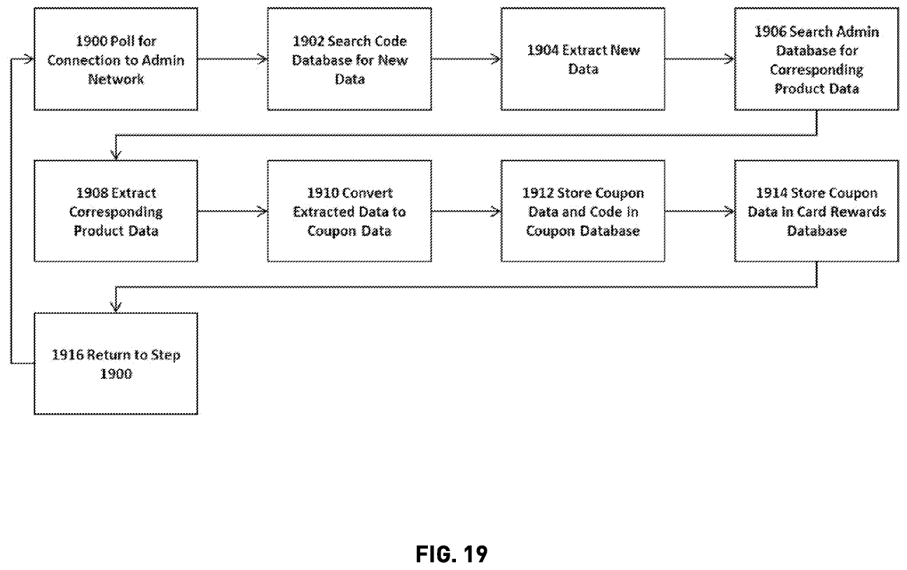

Functioning of the Code to Coupon Module will now be explained with reference to FIG. 19. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 19 displays the method for the Code to Coupon Module, according to some aspects of the disclosure. The process begins with the Card Network Code to Coupon Module 150 polling for a connection to the Admin Network 102. If no connection is available, the Card Network Code to Coupon Module 150 may send an error message to the Admin Network 102 or an administer, at step 1900. The Card Network Code to Coupon Module 150 may search the Admin Network Code Database 118 for any new data. New data may be data that has been added to, or edited in, the Admin Network Code Database 118 since the last time a connection was available, at step 1902. The Card Network Code to Coupon Module 150 may extract the new data from the Admin Network Code Database 118, at step 1904. The Card Network Code to Coupon Module 150 may search the Admin Network Admin Database 112 for the product data that corresponds with the data from the Admin Network Code Database 118. For example, if the code database data has item ID 654123, then the details associated with that item ID would be extracted from the Admin Network Admin Database 112, at step 1906. The Card Network Code to Coupon Module 150 may extract the corresponding product data from the Admin Network Admin Database 112, at step 1908.

The Card Network Code to Coupon Module 150 may convert the extracted product data to data that conforms with coupon data. For example, the discount amount normally associated with the commission plan becomes the discount amount provided by the coupon. The Card Network Code to Coupon Module 150 may generate a coupon code that conforms to the industry standard. The coupon code, discount, or any other relevant data can then be sent to a vendor so that the coupon can be accepted. Alternatively, the Card Network 148 may honor the coupon instead of the vendor at step 1910. The Card Network Code to Coupon Module 150 stores the coupon data and the associated code in the Admin Network Coupon Database 122 so that when the coupon is used, the correct commission plan is applied and the upline user associated with the code is paid commission, at step 1912. The Card Network Code to Coupon Module 150 stores the coupon data and the associated code in the Card Network Card Rewards Database 152 so that the coupon may be used when a user purchases the associated product using a card associated with the Card Network 148, at step 1914. The Card Network Code to Coupon Module 150 may return to step 1900, at step 1916.

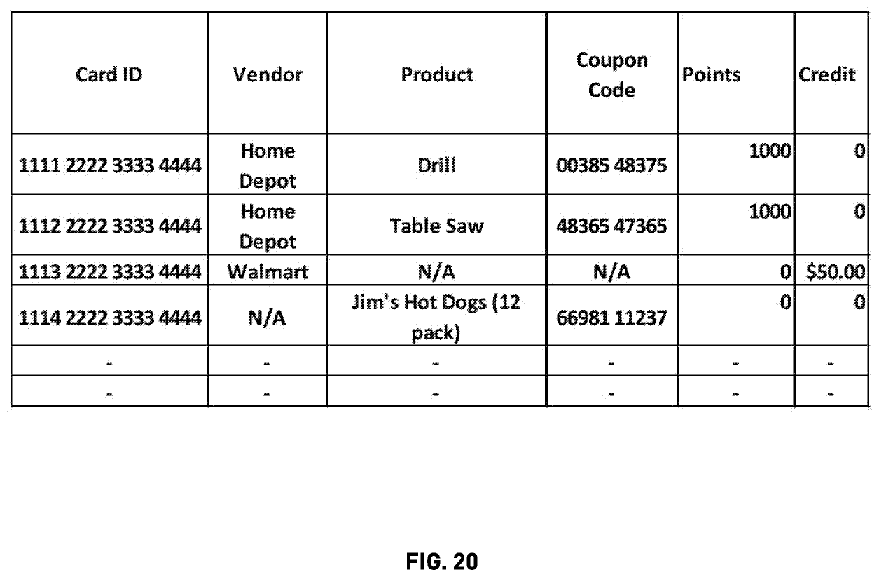

Functioning of the Card Rewards Database will now be explained with reference to FIG. 20. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 20 displays the Card Rewards Database according to some aspects of the disclosure. The Card Network Card Rewards Database 152 may contain rewards associated with a card number or other identifier for a card. The card rewards may be coupons, points, credits, cashback, etc. Each reward may be general, specific to a vendor, specific to a product, specific to both a vendor or a product, etc. For example, a credit card may have a pre-paid $100 in credit that can be used anywhere, or a gift card may have $100 that can only be used at a chain of clothing stores. For another example, a coupon may give 10% off the purchase of a drill anywhere, whereas another coupon may give 20% off the same drill but only when purchased from the manufacturer. Card rewards may be exclusive or may be combinable.

While various flow diagrams provided and described above may show a particular order of operations performed by certain embodiments of the disclosure, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for code-based tracking of online activities for rewards assignments, the method comprising:
storing a first code in memory, wherein the first code is associated with a first user within a tree structure associated with an online activity and a rewards system;
receiving information sent over a communication network that a user device of a second user is interacting with a link associated with the online activity, wherein the first code is embedded in the link;
identifying a first set of upline users including the first user associated with the interaction based on the first code embedded in the link;
updating a rewards database to store one or more rewards allocated to each the identified first set of upline users in accordance with a respective rewards system;
generating a second code to assign to the second user, wherein the second code is generated at the computer based on information associated with the first set of upline users including the first user;
receiving information sent over a communication network regarding interaction with the online activity via a link that has the second code embedded therein; and
identifying a second set of upline users including the first user and the second user based on the use of the second code to interact with the online activity

2. The method of claim 1, further comprising identifying the interaction by the user device of the second user with the online activity further based on data from a third party network computer.

3. The method of claim 1, wherein one or more of the rewards are associated with a respective card of one of the upline users, and wherein the rewards are applicable to a subsequent online activity.

4. The method of claim 1, wherein identifying the first set of upline users comprises comparing the first code to a plurality of codes stored in a memory.

5. The method of claim 1, wherein generating the second code is further based on a sphere of influence of the first user.

6. The method of claim 1, wherein the first code is stored in association with a dynamic user structure associated with the rewards system, and wherein the rewards are allocated based on a comparison of information associated with the first code to information regarding one or more downline users in the dynamic user structure associated with the rewards system.

7. The method of claim 1, wherein the online activity is initiated upon selection of the coded link via the user device of the second user, and wherein initiating the online activity includes automatically generating a graphic user interface associated with the online activity at the user device of the second user.

8. The method of claim 1, further comprising generating the link embedded with the second code, and storing the second code and link embedded with the second code in the database in association with the second user.

9. The method of claim 8, wherein the link embedded with the second code is associated with a same or different website of the online activity.

10. The method of claim 1, wherein the link embedded with the second code is shareable with one or more other users not currently stored in the database.

11. A non-transitory computer-readable storage medium having embodied thereon a program executable by a processor to perform a method for code-based tracking of online activities for rewards assignments, the method comprising:
storing a first code in memory, wherein the first code is associated with a first user within a tree structure associated with an online activity and a rewards system;
receiving information sent over a communication network that a user device of a second user is interacting with a link associated with the online activity, wherein the first code is embedded in the link;
identifying a first set of upline users including the first user associated with the interaction based on the first code embedded in the link;
updating a rewards database to store one or more rewards allocated to each the identified first set of upline users in accordance with a respective rewards system;
generating a second code to assign to the second user, wherein the second code is generated at the computer based on information associated with the first set of upline users including the first user;
receiving information sent over a communication network regarding interaction with the online activity via a link that has the second code embedded therein; and
identifying a second set of upline users including the first user and the second user based on the use of the second code to interact with the online activity.

12. The non-transitory computer-readable storage medium of claim 11, further comprising instructions executable to identify the interaction by the user device of the second user with the online activity further based on data from a third party network computer.

13. The non-transitory computer-readable storage medium of claim 11, wherein one or more of the rewards are associated with a respective card of one of the upline users, and wherein the rewards are applicable to a subsequent online activity.

14. The non-transitory computer-readable storage medium of claim 11, wherein identifying the first set of upline users comprises comparing the first code to a plurality of codes stored in a memory.

15. The non-transitory computer-readable storage medium of claim 11, wherein generating the second code is further based on a sphere of influence of the first user.

16. The non-transitory computer-readable storage medium of claim 11, wherein the first code is stored in association with a dynamic user structure associated with the rewards system, and wherein the rewards are allocated based on a comparison of information associated with the first code to information regarding one or more downline users in the dynamic user structure associated with the rewards system.

17. The non-transitory computer-readable storage medium of claim 11, wherein the online activity is initiated upon selection of the coded link via the user device of the second user, and wherein initiating the online activity includes automatically generating a graphic user interface associated with the online activity at the user device of the second user.

18. The non-transitory computer-readable storage medium of claim 11, further comprising instructions executable to generate the link embedded with the second code of the second user based.

19. The non-transitory computer-readable storage medium of claim 11, wherein the link embedded with the second code is associated with a same or different website of the online activity.

20. The non-transitory computer-readable storage medium of claim 11, wherein the link embedded with the second code is shareable with one or more other users not currently stored in the database.
